(19) United States
(12) Patent Application Publication
(10) Pub. No.: US 2026/0277788 A1
(43) Pub. Date: Sep. 17, 2026

(54) MEMORY SYSTEM AND METHOD

(71) Applicant: Kioxia Corporation, Tokyo (JP)

(72) Inventors: Yasushi UNOKI, Yokohama (JP); Atsushi OKAMOTO, Yokohama (JP)

(73) Assignee: Kioxia Corporation, Tokyo (JP)

(21) Appl. No.: 19/236,177

(22) Filed: Jun. 12, 2025

(30) Foreign Application Priority Data
Mar. 17, 2025 (JP) 2025-042919

(51) Int. Cl. G06F 12/02

(52) U.S. Cl. CPC G06F 12/0246; G06F 2212/7203

(57) ABSTRACT

According to one embodiment, a memory system includes first memories operable in parallel and a memory controller. The memory controller manages multiple groups each including some of the first memories. The multiple groups include a first group and a second group. The memory controller causes each of the first memories to perform a first erase operation such that the some of the first memories included in each of the multiple groups are caused to perform the first erase operation at timing different among the multiple groups. The memory controller causes one or more of the first memories included in the second group to perform a program operation or a sense operation while the first erase operation is being performed in each of the some of the first memories included in the first group.

### CROSS-REFERENCE TO RELATED APPLICATIONS

This application is based upon and claims the benefit of priority from Japanese Patent Application No. 2025-042919, filed on Mar. 17, 2025, the entire contents of which are incorporated herein by reference.

### FIELD

Embodiments described herein relate generally to a memory system and a method.

### BACKGROUND

In a memory system including a plurality of memory chips and a memory controller, the memory controller may be configured to be capable of operating the memory chips in parallel. In such a system, the memory controller writes data received from a host into the memory chips in parallel.

### BRIEF DESCRIPTION OF THE DRAWINGS

FIG. 1 illustrates an exemplary configuration of a memory system according to an embodiment;

FIG. 2 illustrates an exemplary configuration of a memory chip according to the embodiment;

FIG. 3 illustrates a circuit configuration of a block according to the embodiment;

FIG. 4 illustrates an exemplary configuration of a superblock according to the embodiment;

FIG. 5 is an explanatory diagram for an exemplary state that a superblock according to the embodiment may have;

FIG. 6 illustrates an exemplary configuration of a RAM according to the embodiment;

FIG. 7 is an explanatory diagram for an exemplary erase operation to a superblock according to the embodiment;

FIG. 8 is an explanatory diagram for exemplary temporal transitions in the size of an available storage space of a write buffer according to the embodiment;

FIG. 9 is an explanatory diagram for another exemplary erase operation to a superblock according to the embodiment;

FIG. 10 is a flowchart illustrating an exemplary operation of changing a parameter value according to a modification; and

FIG. 11 is a flowchart illustrating another exemplary operation of changing a parameter value according to the modification.

### DETAILED DESCRIPTION

According to the present embodiment, a memory system includes a first number of first memories and a memory controller. The first number of the first memories are operable in parallel. The first number is an integer of 2 or larger. The memory controller is configured to manage a plurality of groups each including a second number of the first memories. The second number is an integer not smaller than 1 and smaller than the first number. The plurality of groups include at least a first group and a second group. The memory controller causes each of the first number of the first memories to perform a first erase operation such that the second number of the first memories included in each of the plurality of groups are caused to perform the first erase operation at timing different among the plurality of groups. The memory controller causes one or more of the first memories included in the second group to perform a program operation or a sense operation while the first erase operation is being performed in each of the second number of the first memories included in the first group.

Exemplary embodiments of a memory system and a method will be described in detail below with reference to the accompanying drawings. Note that the present invention is not limited to the following embodiments.

### Embodiments

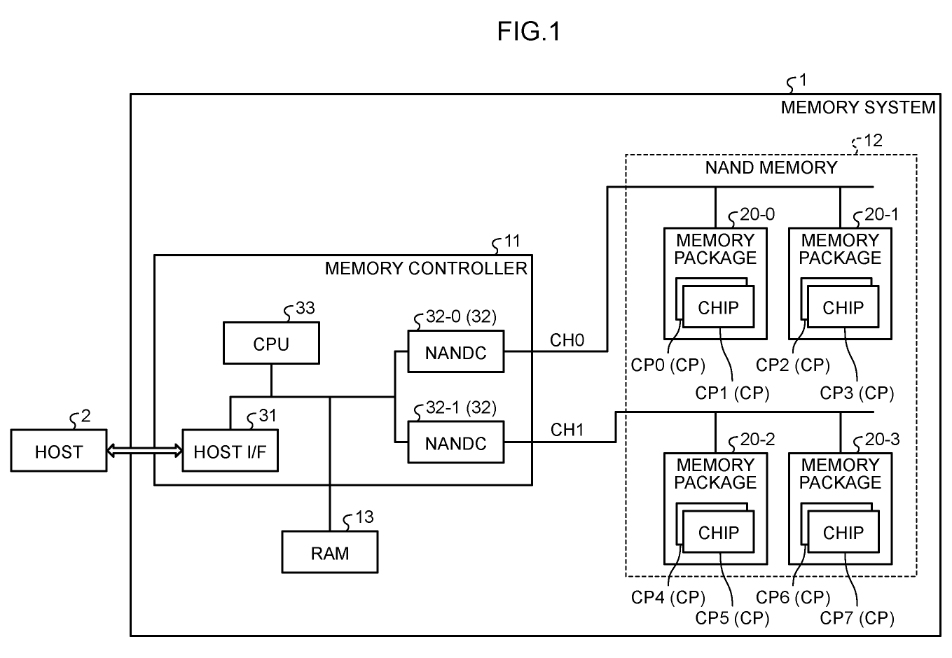

FIG. 1 illustrates an exemplary configuration of a memory system according to an embodiment.

A memory system 1 may be connected to a host 2 with a predetermined communication interface. The host 2 is, for example, a processor, a personal computer, a mobile information terminal, or a server. The memory system 1 receives various access requests from the host 2. The various access requests include a write request and a read request.

The memory system 1 includes a memory controller 11, a nonvolatile memory 12, and a random access memory (RAM) 13. The nonvolatile memory 12 is, for example, a NAND flash memory. Hereinafter, the nonvolatile memory 12 is referred to as a NAND memory 12.

The NAND memory 12 is a nonvolatile memory that functions as a storage. The NAND memory 12 includes one or more memory chips (dies) CP. Herein, as an example of the one or more memory chips CP, eight memory chips CP0 to CP7 are illustrated. A plurality of memory chips CP may be encased in resin or the like to form a single package. Herein, as an example, a memory package 20-0 including the memory chips CP0 and CP1, a memory package 20-1 including the memory chips CP2 and CP3, a memory package 20-2 including the memory chips CP4 and CP5, and a memory package 20-3 including the memory chips CP6 and CP7 are illustrated.

The memory controller 11 and the NAND memory 12 are electrically connected through one or more channels. Herein, as an example, the memory system 1 includes two channels CH0 and CH1. The two channels CH0 and CH1 are connected to the memory controller 11. The memory packages 20-0 and 20-1 are connected to the channel CH0, and the memory packages 20-2 and 20-3 are connected to the channel CH1.

The number of channels, the number of memory chips CP, the number of memory packages 20, and the wiring between the memory controller 11 and each memory chip CP in the memory system 1 are not limited to this example.

Note that, in a case where the memory system 1 includes a plurality of channels CH, the memory controller 11 controls the plurality of channels CH simultaneously and individually to operate, in parallel, a plurality of memory chips CP connected one-to-one to the different channels CH. Thus, the memory controller 11 issues commands simultaneously to the plurality of memory chips CP connected one-to-one to the different channels CH to operate the plurality of memory chips CP in parallel. Operating the plurality of memory chips CP connected one-to-one to the different channels CH in parallel is referred to as a channel parallel operation.

Note that, herein, operating a plurality of memory chips CP in parallel corresponds to, for example, operating, while one memory chip CP of the plurality of memory chips CP is operating, the other memory chips CP. The respective timings at which the plurality of memory chips CP starts to operate may be synchronous or asynchronous. The respective timings at which the plurality of memory chips CP stops operating may be synchronous or asynchronous.

In a case where a plurality of memory chips CP is connected to one channel CH, the memory controller 11 can perform bank interleaving because the plurality of memory chips CP connected to the one channel CH can be regarded as belonging to mutually different banks. Bank interleaving is one of parallel operation methods. In the bank interleaving, while a memory chip CP belonging to one bank is accessing data, the memory controller 11 issues a command to a memory chip CP belonging to another bank. Thus, a reduction is made in the total time required for data transfer between the NAND memory 12 and the memory controller 11. A parallel operation by using the bank interleaving is referred to as a bank parallel operation.

In the example illustrated in FIG. 1, the memory system 1 includes the channels CH0 and CH1. Each channel CH has four memory chips CP connected thereto. Therefore, the memory controller 11 can operate two memory chips CP connected one-to-one to the different channels CH, in parallel by using the channel parallel operation.

Further, in the example illustrated in FIG. 1, each channel CH has four memory chips CP thereto. Therefore, the memory controller 11 can control four or fewer memory chips CP connected to each channel CH, in parallel by using the bank parallel operation. For example, the memory controller 11 can control the memory chip CP0, the memory chip CP1, the memory chip CP2, and the memory chip CP3 connected to the channel CH0, in parallel by using the bank parallel operation. The memory controller 11 can operate the memory chip CP4, the memory chip CP5, the memory chip CP6, and the memory chip CP7 connected to the channel CH1, in parallel by using the bank parallel operation.

Thus, the memory controller 11 can operate the memory chips CP0 to CP7 in parallel by using a combination of the channel parallel operation and the bank parallel operation.

The memory controller 11 may be configured as a system-on-a-chip (SoC). Alternatively, the memory controller 11 may be formed of a plurality of semiconductor chips. Part of the memory controller 11 or the entirety thereof may be configured as a field-programmable gate array (FPGA) or an application specific integrated circuit (ASIC). The function of each constituent in the memory controller 11 may be executed by a dedicated hardware circuit, a processor that executes a program (firmware), or a combination thereof.

The memory controller 11 performs various types of processing including data transfer between the host 2 and the NAND memory 12. As a configuration for such various types of processing, the memory controller 11 includes a host interface circuit (host I/F) 31, one or more NAND controllers (NANDCs) 32, and a central processing unit (CPU) 33.

The host I/F 31 controls transfer of information to and from the host 2. Examples of the information to be transferred include a request or data.

The CPU 33 controls the entire memory controller 11, based on a firmware program.

Based on a request from the CPU 33, a NANDC 32 transfers, to a target memory chip CP, a command for access to the NAND memory 12 through a channel, or transfers data corresponding to the command to and from the NAND memory 12. The access to the NAND memory 12 includes a write operation, a read operation, and an erase operation.

In the example illustrated in FIG. 1, the memory controller 11 includes two NANDCs 32-0 and 32-1 as an example of the one or more NANDCs 32. The NANDC 32-0 controls transfer of a command or data through the channel CH0. The NANDC 32-1 controls transfer of a command or data through the channel CH1.

The RAM 13, which is a volatile memory, serves to provide the memory controller 11 with a buffer or a cache. The memory controller 11 can use the RAM 13 as a buffer for data to be transferred between the host 2 and the NAND memory 12 or as an area in which various types of management information are temporarily stored.

Note that, in the example illustrated in FIG. 1, the RAM 13 is disposed outside the memory controller 11. The RAM 13 may be built in the memory controller 11. The RAM 13 included in the memory system 1 is not limited in terms of type, number, and arrangement position. For example, the RAM 13 may be a dynamic random access memory (DRAM), a static random access memory (SRAM), or a combination thereof. In a case where the RAM 13 is form of a combination of a DRAM and a SRAM, the SRAM may be built in the memory controller 11 and the DRAM may be disposed outside the memory controller 11.

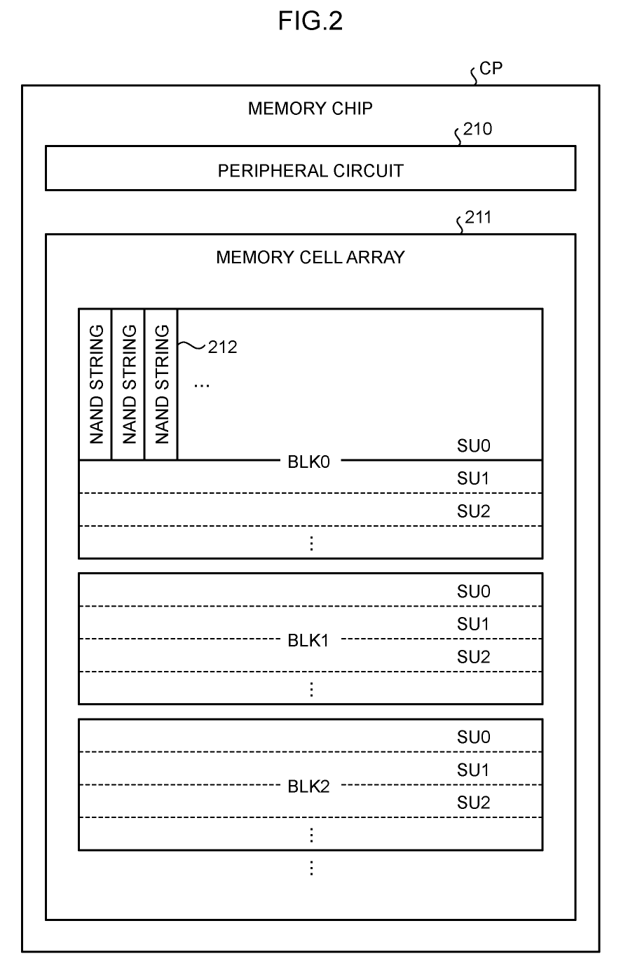

FIG. 2 illustrates an exemplary configuration of a memory chip CP according to the embodiment. The memory chip CP includes a peripheral circuit 210 and a memory cell array 211.

The memory cell array 211 includes a plurality of blocks BLK (BLK0, BLK1, BLK2, ...). Each block BLK includes a plurality of string units SU (SU0, SU1, SU2, ...). Each string unit SU includes a plurality of NAND strings 212. Each NAND string 212 includes a plurality of nonvolatile memory cell transistors connected in series. Note that the number of NAND strings 212 in each string unit SU may be any number. The number of memory cell transistors in each NAND string 212 may be any number.

The peripheral circuit 210 includes, for example, a row decoder, a column decoder, a sense amplifier, a latch circuit, and a voltage generation circuit. When receiving a command from the memory controller 11, the peripheral circuit 210 operates in accordance with the received command.

In accordance with the received command, the peripheral circuit 210 can perform, for example, a data-in operation, a program operation, a sense operation, a data-out operation, or an erase operation. The data-in operation corresponds to an operation of importing, into the latch circuit in the peripheral circuit 210, data input from the memory controller 11 to the memory chip CP. The program operation corresponds to an operation of writing, into the memory cell array 211, the data imported in the latch circuit through the data-in operation. The sense operation corresponds to an operation of transferring data stored in the memory cell array 211 to the latch circuit in the peripheral circuit 210. The data-out operation corresponds to an operation of outputting the data stored in the latch circuit to the memory controller 11. The erase operation corresponds to an operation of erasing data stored in the memory cell array 211.

In the write operation, the memory controller 11 causes the peripheral circuit 210 to perform the data-in operation to import write data into the latch circuit. Then, the memory controller 11 causes the peripheral circuit 210 to perform the program operation to store the write data into the memory cell array 211.

In the read operation, the memory controller 11 causes the peripheral circuit 210 to perform the sense operation to transfer data stored in the memory cell array 211 to the latch circuit. Then, the memory controller 11 causes the peripheral circuit 210 to perform the data-out operation to output the data stored in the latch circuit to the memory controller 11. Note that, in a case where data to be read is already stored in the latch circuit, the sense operation may be omitted.

Note that the peripheral circuit 210 and the memory cell array 211 may be divided into a plurality of units called planes mutually independently operable.

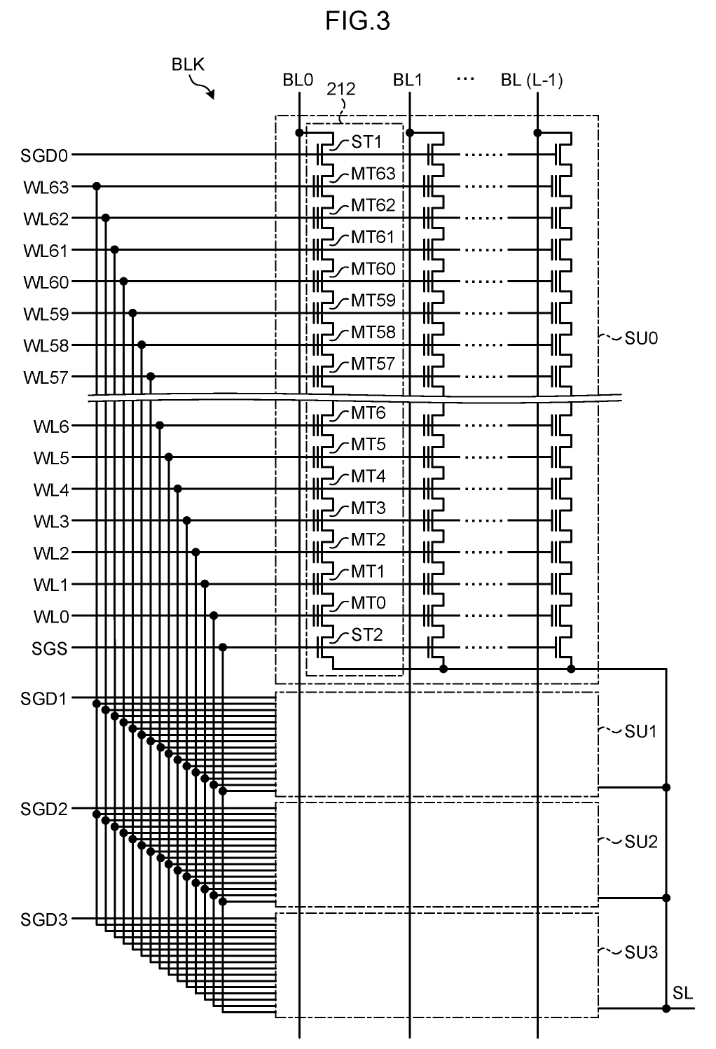

FIG. 3 illustrates a circuit configuration of a block BLK according to the embodiment. Note that the blocks BLK are identical in configuration. Such a block BLK includes, for example, four string units SU0 to SU3. Each string unit SU includes a plurality of NAND strings 212.

The NAND strings 212 each include, for example, 64 memory cell transistors MT (MT0 to MT63) and selection transistors ST1 and ST2. The memory cell transistors MT each include a control gate and a charge accumulation layer, and store data in a nonvolatile manner in accordance with a threshold voltage. The 64 memory cell transistors MT (MT0 to MT63) are connected in series between the source of the selection transistor ST1 and the drain of the selection transistor ST2. Note that the memory cell transistors MT may be of a metal-oxide-nitride-oxide-silicon (MONOS) type including an insulating film used for the charge accumulation layer or may be of a floating gate (FG) type including a conductive film used for the charge accumulation layer. The number of memory cell transistors MT in each NAND string 212 is not limited to 64.

The gates of the selection transistors ST1 included in the string unit SU0 are connected to a selection gate line SGD0. The gates of the selection transistors ST1 included in the string unit SU1 are connected to a selection gate line SGD1. The gates of the selection transistors ST1 included in the string unit SU2 are connected to a selection gate line SGD2. The gates of the selection transistors ST1 included in the string unit SU3 are connected to a selection gate line SGD3. In contrast to this, the gates of the selection transistors ST2 included in the string units SU0 to SU3 are connected in common to a selection gate line SGS, for example. Note that the gates of the selection transistors ST2 included in the string unit SU0 may be connected to a selection gate line SGS0 (not illustrated). The gates of the selection transistors ST2 included in the string unit SU1 may be connected to a selection gate line SGS1 (not illustrated). The gates of the selection transistors ST2 included in the string unit SU2 may be connected to a selection gate SGS2 (not illustrated). The gates of the selection transistors ST2 included in the string unit SU3 may be connected to a selection gate SGS3 (not illustrated). The control gates of the memory cell transistors MT0 to MT63 in each NAND string 212 included in the same block BLK are connected to word lines WL0 to WL63, respectively.

The drains of the respective selection transistors ST1 of the NAND strings 212 included in each string unit SU are connected one-to-one to mutually different bit lines BL (BL0 to BL(L - 1) where L is a natural number of 2 or larger). The bit lines BL each connect one of the NAND strings 212 included in each string unit SU, in common among the blocks BLK. The sources of the selection transistors ST2 are connected in common to a source line SL.

Thus, the string units SU are each an aggregate of NAND strings 212 in which the NAND strings 212 are connected one-to-one to the different bit lines BL and are connected to the same selection gate line SGD. The blocks BLK are each an aggregate of string units SU in which the string units SU share the word lines WL. Then, the memory cell array 211 is an aggregate of blocks BLK in which the blocks BLK share at least one bit line BL.

The program operation and the sense operation by the peripheral circuit 210 may be performed to the memory cell transistors MT connected to one word line WL in one string unit SU, collectively.

The erase operation by the peripheral circuit 210 is performed in units of blocks BLK. Thus, all the pieces of data stored in one block BLK are erased collectively.

The configuration of the memory cell array 211 is not limited to the configurations illustrated in FIGS. 2 and 3. For example, the memory cell array 211 may have a configuration in which the NAND strings 212 are arrayed two-dimensionally or three-dimensionally.

The memory controller 11 sets superblocks. Each superblock is formed of a plurality of blocks BLK accessible in parallel.

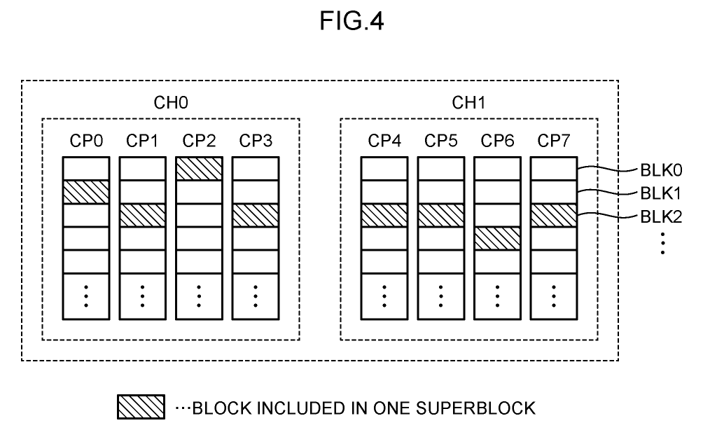

FIG. 4 illustrates an exemplary configuration of a superblock according to the embodiment.

In the example illustrated in FIG. 1, by using the combination of the channel parallel operation and the bank parallel operation, the memory controller 11 can operate the memory chips CP0 to CP7 in parallel. As illustrated in FIG. 4, one block BLK is selected from each of the memory chips CP0 to CP7, and an aggregation of the respective blocks BLK selected from the memory chips CP0 to CP7 constitutes one superblock. The blocks BLK in combination that form one superblock may be fixed or may be changed dynamically. Note that, different superblocks include different blocks BLK each selected from each memory chip CP. In other words, one block BLK is not allowed to be included in two or more superblocks.

The memory controller 11 controls the write operation, the read operation, and the erase operation in units of superblocks. Thus, the memory controller 11 performs state management in units of superblocks.

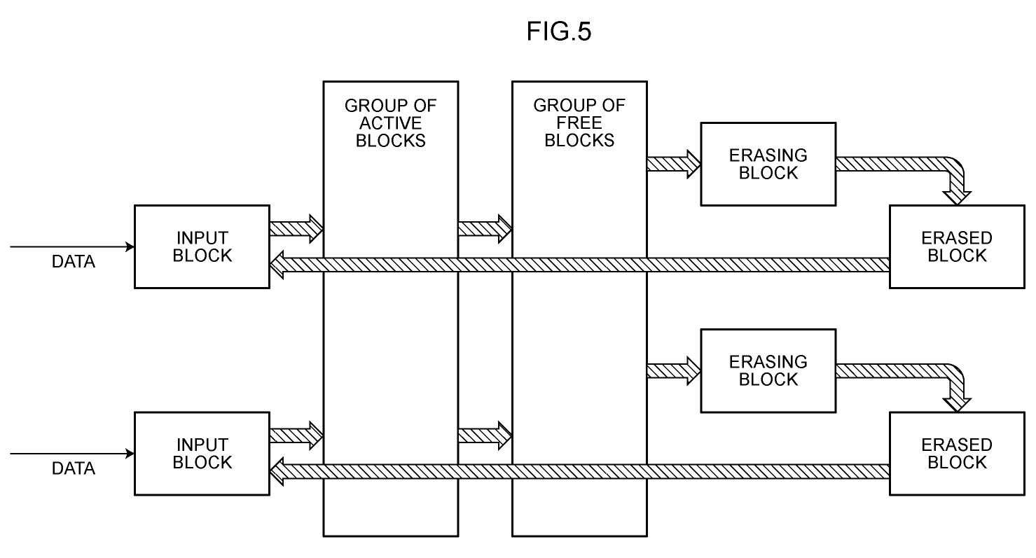

FIG. 5 is an explanatory diagram for an exemplary state that a superblock according to the embodiment may have.

A superblock may have an input state, an active state, a free state, an erasing state, or an erased state. The superblock in the input state may be referred to as an input block. The superblock in the active state may be referred to as an active block. The superblock in the free state may be referred to as a free block. The superblock in the erasing state may be referred to as an erasing block. The superblock in the erased state may be referred to as an erased block.

The input state corresponds to the state of a superblock set as a storage destination for new data. The input block includes an area in which no data is stored. New data received from the memory controller 11 is stored in the area in which no data is stored.

In the example illustrated in FIG. 5, two superblocks are set as input blocks. The number of input blocks is not limited to two.

In a case where, for example, the memory system 1 supports a multi-stream write function, an input block may be provided for each stream. In addition to an input block into which data is stored in response to a write request from the host 2 (namely, an input block into which data required to be written by a write request is stored), a dedicated input block for a garbage collection operation, described later, may be provided.

The active state corresponds to the state of a superblock to which data storage has been completed and no new data storage is performed. The active state also corresponds to the state of a superblock not ready to be reused. That is, a superblock in the active state is not ready to transition to the input state.

When data for one superblock is stored into a superblock in the input state, the superblock transitions from the input state to the active state. The state of the data stored in the superblock in the active state is either a valid state or an invalid state. Hereinafter, data in the valid state is referred to as valid data, and data in the invalid state is referred to as invalid data.

When certain data (referred to as first data) is stored in a superblock in the active state (referred to as a first superblock), the host 2 may transmit second data to the memory system 1. The logical address designated for the second data is identical in value to the logical address of the first data. In such a case, the memory controller 11 stores the second data into a superblock in the input state, which is different from the first superblock, and makes the first data stored in the first superblock invalid. In this way, data stored in a superblock in the active state may include valid data and invalid data.

The memory controller 11 performs a garbage collection operation to a superblock in the active state at a predetermined timing. The garbage collection operation corresponds to an operation of transcribing all valid data stored in a certain superblock to another superblock in the input state. Due to the garbage collection operation, all the data stored in the superblock as the transcribing source is made invalid, and thereby the superblock as the transcribing source transitions from the active state to the free state.

The free state corresponds to the state of a superblock in which all the stored data is made invalid. The erase operation is performed to a superblock in the free state, for example, when a new input block is required.

The erase operation is performed to all blocks BLK forming a superblock. Although a detailed description will be given later, in the embodiment, the erase operation to each of the blocks BLK forming a superblock is performed in a temporal dispersion manner. When the erase operation to all the blocks BLK forming a superblock is completed, the erase operation to the superblock is regarded as completed.

The erasing state corresponds to the state of a superblock from when the erase operation to any of the blocks BLK forming the superblock starts until the erase operation to all the blocks BLK forming the superblock is completed. Thus, the erasing state corresponds to the state of a superblock to which the erase operation is being performed.

The erased state corresponds to the state of a superblock having all the blocks BLK to which the erase operation is completed. A superblock in the erased state can transition to the input state.

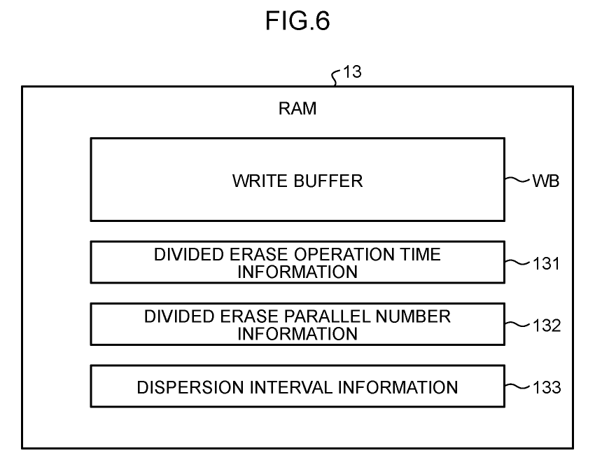

FIG. 6 illustrates an exemplary configuration of the RAM 13 according to the embodiment.

A write buffer WB is allocated to the RAM 13. Data required to be written due to a write request from the host 2 (hereinafter, referred to as write data) is temporarily stored in the write buffer WB. Then, the write data stored in the write buffer WB is subjected to predetermined data processing including error collection coding and then is written to the NAND memory 12.

In a case where a write request is received from the host 2, when write data required to be written by the write request is completely stored into the write buffer WB, the memory controller 11 sends, to the host 2, a notification of completion of execution based on the write request (hereinafter, referred to as a write completion notification). Note that the timing at which the write completion notification is sent is not limited to this example.

A technique compared to the embodiment will be described. The technique compared to the embodiment is referred to as a comparative example. According to the comparative example, in the erase operation to a superblock, the erase operation is performed to all blocks forming the superblock, simultaneously. Thus, all memory chips operable in parallel perform respective erase operations, simultaneously.

A memory chip performing the erase operation can perform neither the program operation nor the sense operation. Therefore, according to the comparative example, while the erase operation to one superblock is being performed, the memory controller is not allowed to perform the write operation to any memory chip, leading to stagnation of output of write data from the write buffer. Write data received from the host during the erase operation is successively accumulated into the write buffer, and then the available storage space of the write buffer may be exhausted. When the available storage space of the write buffer is exhausted, no new write data can be received. Thus, an increase is made in the time from when a write request is received until the write completion notification is sent, namely, in the response time to the write request. Therefore, according to the comparative example, the amount of variation is large in the response time to the write request.

An increase in the size of the write buffer can prevent the available storage space of the write buffer from being exhausted, and thereby a variation can be reduced or eliminated in the response time to the write request. However, in order to increase the size of the write buffer, a RAM with a large storage capacity is required for the memory system, leading to a disadvantage in costs.

Thus, according to the embodiment, for the erase operation to a superblock, the memory controller 11 temporally disperses the erase operation to the blocks BLK forming the superblock.

Specifically, the memory controller 11 divides the eight memory chips CP0 to CP7 into multiple groups and makes the timing of the erase operation to each block BLK included in a superblock different among the groups.

Moreover, each memory chip CP has an erase suspend function. The erase suspend function corresponds to a function of suspending or resuming an erase operation to one block BLK. During suspension of the erase operation, the memory chip CP can perform the program operation or the sense operation to a block BLK different from the block BLK to which the erase operation is suspended. The memory controller 11 causes each memory chip CP to perform the erase operation in a plurality of steps by using the erase suspend function. Partial operations divided from one erase operation are each referred to as a divided erase operation.

As parameter values for controlling the erase operation to one superblock, divided erase operation time information 131, divided erase parallel number information 132, and dispersion interval information 133 are stored in the RAM 13.

Divided erase operation time is recorded in the divided erase operation time information 131. The divided erase operation time is a set value for the length of time from when one erase operation (namely, one divided erase operation) starts until it is suspended. A divided erase parallel number is recorded in the divided erase parallel number information 132. The divided erase parallel number is a set value for the number of memory chips CP that are allowed to simultaneously perform one divided erase operation. A value that is not smaller than 1 and smaller than the number of memory chips CP may be set as the divided erase parallel number. A dispersion interval is recorded in the dispersion interval information 133. The dispersion interval is a set value for the time interval from when a certain group performs a divided erase operation until another group performs a divided erase operation. Each group includes a plurality of memory chips CP. The number of memory chips CP in each group is equal to the divided erase parallel number.

The pieces of information 131 to 133 are determined by a designer and are stored in a predetermined nonvolatile storage area (e.g., the NAND memory 12). Then, for example, when the memory system 1 starts up, the pieces of information 131 to 133 are loaded into the RAM 13. The memory controller 11 uses the pieces of information 131 to 133 loaded in the RAM 13.

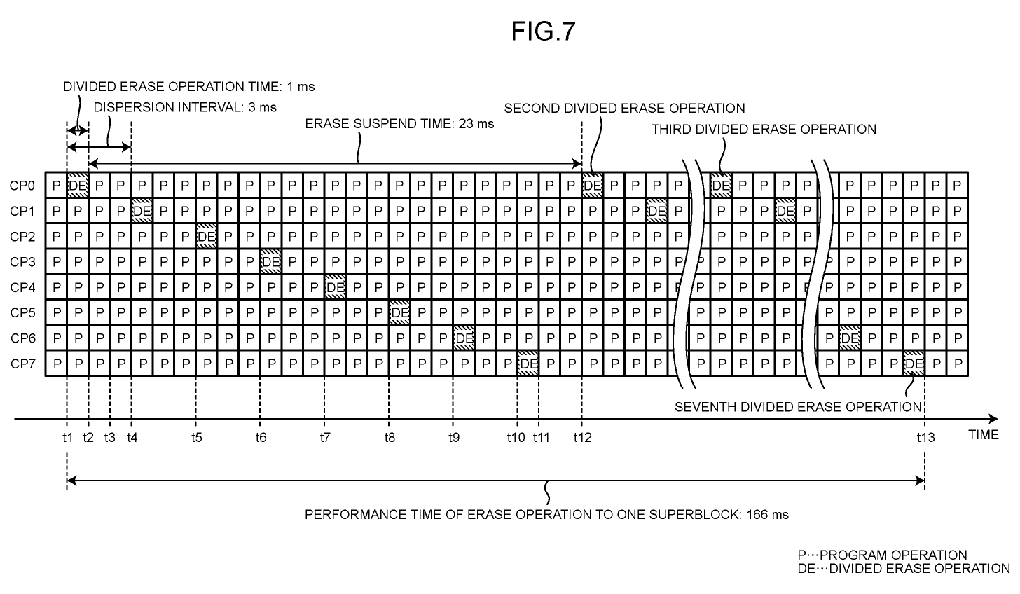

FIG. 7 is an explanatory diagram for an exemplary erase operation to a superblock according to the embodiment. In the drawing, the respective temporal transitions of operations performed in the memory chips CP0 to CP7 are illustrated. In the drawing, "P" represents the program operation that is being performed in a memory chip CP, and "DE" represents the divided erase operation that is being performed in a memory chip CP. In the description with FIG. 7, one superblock to which the erase operation is to be performed is referred to as a target superblock.

Note that, in the example illustrated in FIG. 7, the divided erase operation time is set to 1 millisecond (ms) and the divided erase parallel number is set to 1. In addition, the dispersion interval is set to 3 ms. By performing seven divided erase operations for each block BLK of one superblock, the erase operation to the superblock is completed.

The memory controller 11 causes the memory chip CP0 to perform the first divided erase operation, and thereby the erase operation to the target superblock is started (time t1). The memory controller 11 causes the state of the target superblock to transition from the free state to the erasing state at the timing when the erase operation to the target superblock starts.

The memory controller 11 causes the memory chips CP1 to CP7 to perform the program operation while the first divided erase operation is being performed in the memory chip CP0, namely, during 1 ms from time t1 to time t2.

At time t2, the erase operation in the memory chip CP0 is suspended by the memory controller 11 (that is, one divided erase operation is made terminated). Then, the memory controller 11 causes the memory chips CP0 to CP7 to perform the program operation during 2 ms from time t2 to time t4.

The memory controller 11 causes the memory chip CP1 to perform the first divided erase operation at time t4, namely, after an elapse of 3 ms, which is set as the dispersion interval, from time t1. Similarly, the memory controller 11 causes the memory chip CP2 to perform the first divided erase operation at time t5 after an elapse of 3 ms from time t4. The memory controller 11 causes the memory chip CP3 to perform the first divided erase operation at time t6 after an elapse of 3 ms from time t5. The memory controller 11 causes the memory chip CP4 to perform the first divided erase operation at time t7 after an elapse of 3 ms from time t6. The memory controller 11 causes the memory chip CP5 to perform the first divided erase operation at time t8 after an elapse of 3 ms from time t7. The memory controller 11 causes the memory chip CP6 to perform the first divided erase operation at time t9 after an elapse of 3 ms from time t8. The memory controller 11 causes the memory chip CP7 to perform the first divided erase operation at time t10 after an elapse of 3 ms from time t9.

At time t11 after an elapse of 1 ms from time t10, the respective first divided erase operations in the memory chips CP0 to CP7 have been completed. The memory controller 11 causes the memory chip CP0 to perform the second divided erase operation at time t12 after an elapse of 3 ms, which is set as the dispersion interval, from time t10.

In a case where the divided erase operation is being performed in one memory chip CP in the period from time t4 to time t12, the memory controller 11 causes the other memory chips CP, different from the one memory chip CP that is performing the divided erase operation, to perform the program operation, similarly from time t1 to time t2. In a case where no divided erase operation is being performed in any memory chip CP, the memory controller 11 causes the memory chips CP0 to CP7 to perform the program operation, similarly from time t2 to time t4.

In a procedure similar to the procedure for the respective first divided erase operations in the memory chips CP0 to CP7, the memory controller 11 causes the memory chips CP0 to CP7 to perform each of the second to seventh divided erase operations. Thus, after causing the memory chips CP0 to CP7 to perform the N-th divided erase operation (N is an integer of 1 or larger and 6 or smaller), the memory controller 11 causes, per time interval set as the dispersion interval, the memory chips CP0 to CP7 to perform the (N + 1)-th divided erase operation.

At time t13 after an elapse of 166 ms from time t1, the seventh divided erase operation in the memory chip CP7 is completed, and thereby the erase operation to the target superblock is completed. At the timing of completion of the erase operation to the target superblock, the memory controller 11 causes the state of the target superblock to transition from the erasing state to the erased state.

As explained above, the program operation is performed to a superblock in the input state. This means that, at least in the period from time t1 to time t13, another superblock different from the target superblock is set as the input block. The memory controller 11 causes the memory chips CP0 to CP7 to perform the respective program operations one-to-one to the blocks BLK forming the input block. For example, in the period from time t1 to time t2, the block BLK to which the program operation is performed in each of the memory chips CP1 to CP7 is not any block BLK in the target superblock but is a block BLK included in the input block. In the period from time t2 to time t4, the block BLK to which the program operation is performed in each of the memory chips CP0 to CP7 is not any block BLK in the target superblock but is a block BLK included in the input block.

Note that, in the example illustrated in FIG. 7, in a case where the divided erase operation is being performed in one memory chip CP, the other memory chips CP different from the one memory chip CP that is performing the divided erase operation perform the program operation. In a case where no divided erase operation is being performed in any memory chip CP, all the memory chips CP perform the program operation. The program operation is not necessarily performed in all the memory chips CP in which no divided erase operation is being performed. The program operation may be performed in some of the memory chips CP in which no divided erase operation is being performed. Further, any memory chip CP in which no divided erase operation is being performed may perform the sense operation, instead of the program operation.

In a case where a memory chip CP in which no divided erase operation is being performed performs the sense operation, the sense operation is performed to a block BLK included in an input block or a block BLK included in an active block.

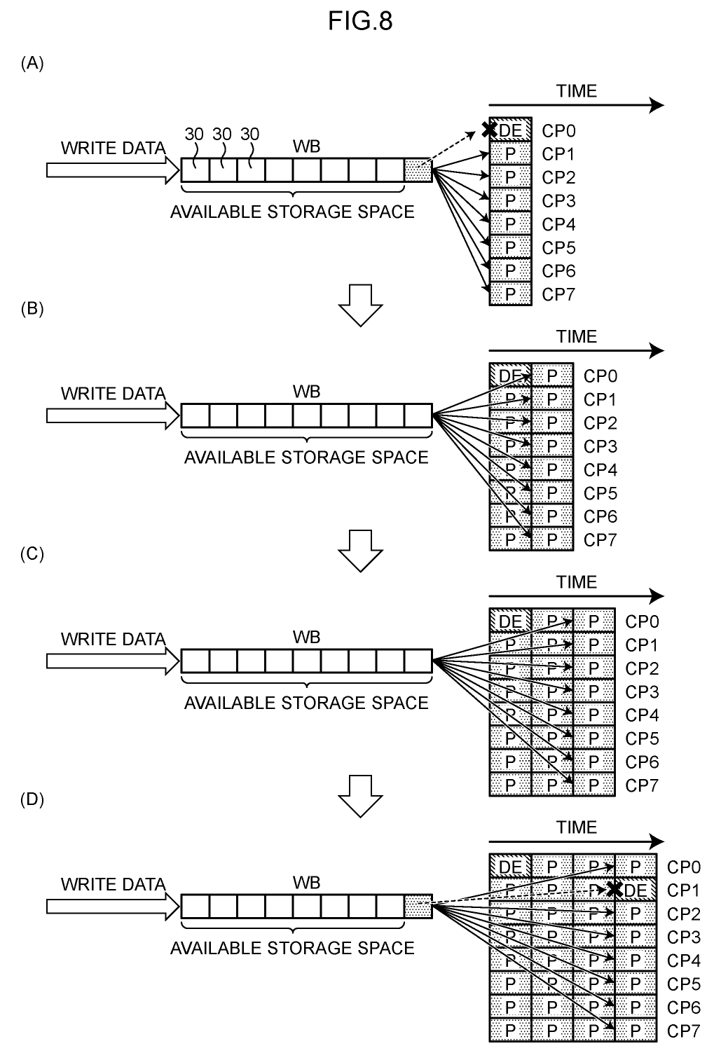

FIG. 8 is an explanatory diagram for exemplary temporal transitions in the size of the available storage space of the write buffer WB according to the embodiment. In the description with the drawing, for easy understanding, an amount of data writable to one memory chip CP in every divided erase operation time is defined as one data unit, and approximately eight data units of write data are transmitted from the host 2 to the memory system 1 in every divided erase operation time. In addition, the write buffer WB has a storage size of nine data units. In FIG. 8, each rectangle 30 constituting the write buffer WB is a storage area having a size of one data unit.

At time t1 illustrated in FIG. 7, the program operation is performed in each of the seven memory chips CP different from the memory chip CP0 that starts the divided erase operation. Therefore, as illustrated in Part (A) of FIG. 8, at time t1, of eight data units of write data received from the host 2, seven data units of write data are written from the write buffer WB to the seven memory chips CP and the remaining one data unit of write data stays in the write buffer WB. Therefore, the write buffer WB has an available storage space corresponding to the size of eight data units.

At time t2 illustrated in FIG. 7, the program operation is performed in each of the eight memory chips CP. Therefore, as illustrated in Part (B) of FIG. 8, no write data stays in the write buffer WB. Thus, the write buffer WB has an available storage space corresponding to the size of nine data units.

Similarly, at time t3 illustrated in FIG. 7, the program operation is performed in each of the eight memory chips CP. Therefore, as illustrated in Part (C) of FIG. 8, no write data stays in the write buffer WB. Thus, the write buffer WB has an available storage space corresponding to the size of nine data units.

At time t4 illustrated in FIG. 7, the program operation is performed in each of the seven memory chips CP different from the memory chip CP1 that starts the divided erase operation. Therefore, as illustrated in Part (D) of FIG. 8, of eight data units of write data received from the host 2, seven data units of write data are written from the write buffer WB to the seven memory chips CP and the remaining one data unit of write data stays in the write buffer WB. Therefore, the write buffer WB has an available storage space corresponding to the size of eight data units.

As above, according to the embodiment, even in a case where the divided erase operation is being performed in one memory chip CP, which corresponds to the number set as the divided erase parallel number, of the eight memory chips CP, the memory controller 11 can cause the remaining seven memory chips CP to perform the program operation during the divided erase operation. Thus, the amount of write data staying in the write buffer WB can be reduced, which can prevent the exhaustion of an available storage space in the write buffer WB. Therefore, differently from the comparative example, the write buffer WB can receive new write data all the time, leading to achieve a reliable response performance to a write request.

Note that, in the above-described example, the divided erase parallel number is 1. The divided erase parallel number may be 2 or larger.

As a case, a limit may be set on an erase suspend time, which is the time from when the divided erase operation is suspended until it is resumed. The erase suspend time increases as the number of memory chips CP in the memory system 1 increases. The erase suspend time increases as the divided erase parallel number decreases. The erase suspend time increases as the dispersion interval lengthens.

For example, in the case described with FIG. 7, the erase suspend time is 23 ms. In a case where the number of memory chips CP is 64 (referred to as Case 1), the erase suspend time is 191 ms on condition that the divided erase operation time and the dispersion interval are identical to those in the case described with FIG. 7.

In a case where the upper limit of the erase suspend time is 100 ms in Case 1, for example, the designer increases the divided erase parallel number to achieve a reduction in the erase suspend time.

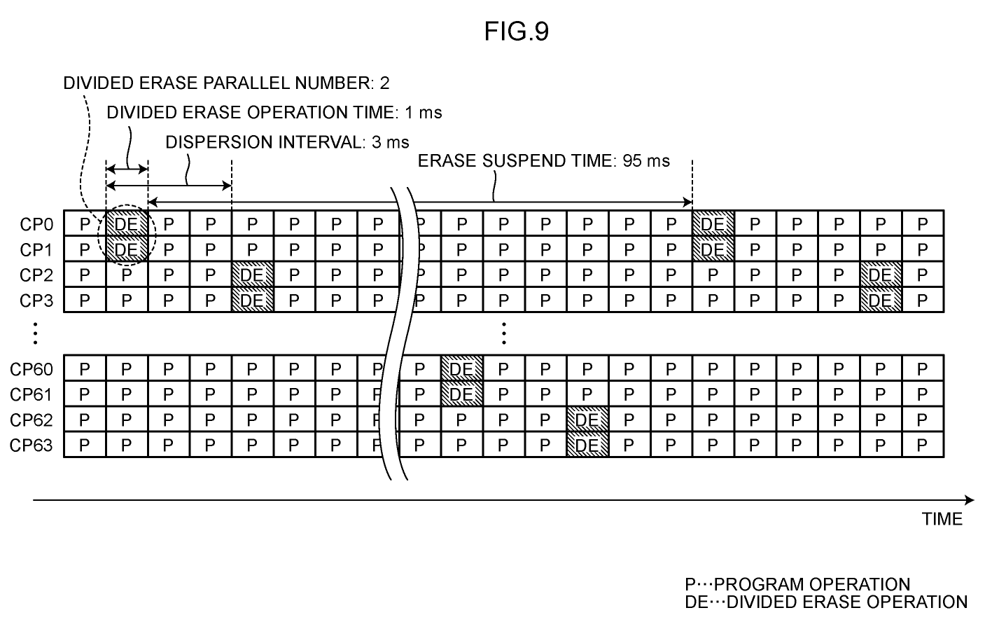

FIG. 9 is an explanatory diagram for an exemplary erase operation to a superblock in a case where the divided erase parallel number is set to 2 in Case 1.

In the example illustrated in FIG. 9, 64 memory chips CP0 to CP63 are grouped into multiple groups. The number of the memory chips CP in each of the groups is 2, which is equal to the divided erase parallel number. For example, the memory chip CP0 and the memory chip CP1 constitute one group, and the memory chip CP2 and the memory chip CP3 constitute another one group. The memory controller 11 causes those groups to successively perform the divided erase operation at time intervals of 3 ms, which is set as the dispersion interval. In a case where the erase operation is performed as above, the erase suspend time is 95 ms. In this way, the erase suspend time is reduced to be not more than the upper limit.

Note that the designer can reduce the erase suspend time by decreasing the dispersion interval instead of increasing the divided erase parallel number. For example, in Case 1, even if the divided erase parallel number is set to 1, the erase suspend time can be reduced to 95 ms by changing the dispersion interval from 3 ms to 1.5 ms.

In the embodiment, the eight memory chips CP0 to CP7 in the description with FIGS. 1 to 8, as well as the 64 memory chips CP0 to CP63 in the example illustrated in FIG. 9, are an example of a first number of first memories. The RAM 13 is an example of a second memory. The divided erase parallel number is an example of a second number. Each block BLK is an example of a storage area. Each block BLK is also an example of a first storage area. Each superblock is an example of a second storage area.

The number of divided erase operations necessary to erase the data stored in one block BLK is an example of an R. The write data received from the host 2 is an example of first data. The erase suspend time is an example of a second set time. The dispersion interval is an example of a first set time. The first divided erase operation performed to each block BLK is an example of a first erase operation.

Note that, in the above description, the erase operation is completed by multiple times of the divided erase operations. The erase operation is not necessarily divided into the multiple divided erase operations. In other words, the data stored in each block BLK may be erased by a single erase operation. In a case where the data stored in each block BLK is erased by a single erase operation, the first erase operation corresponds to the singe erase operation performed to each block BLK.

As described above, according to the embodiment, the memory controller 11 causes each of first number of memory chips CP to perform a first erase operation. The memory controller 11 manages a plurality of groups each including one or more memory chips CP. A second number that is the number of memory chips CP in each of the groups is an integer that is not smaller than 1 and is smaller than the first number. The groups include at least a first group and a second group. The memory controller 11 causes the second number of memory chips CP included in each group to perform the first erase operation at timing different among the groups. The memory controller 11 causes one or more memory chips CP included in the second group to perform the program operation or the sense operation while the first erase operation is being performed in each of the second number of memory chips CP included in the first group.

Therefore, the available storage space in the write buffer WB is prevented from being exhausted due to the erase operation to a superblock. Thus, reliable response performance to a write request can be achieved.

In addition, according to the embodiment, the data stored in one block BLK is erased by R number of divided erase operations. The memory controller 11 causes each of the second number of memory chips CP included in the first group to perform, at time t1, the M-th erase operation of the R number of erase operations. M is an integer that is not smaller than 1 and is not larger than (R - 1). The memory controller 11 causes each of the second number of memory chips CP included in the second group to perform, at time t4, the M-th erase operation of the R number of erase operations. The memory controller 11 causes each of the second number of memory chips CP included in the first group to perform, at time t12, the (M + 1)-th erase operation of the R number of erase operations. The memory controller 11 causes the one or more memory chips CP included in the second group to perform the program operation or the sense operation in the period from time t1 to time t2.

Therefore, the available storage space in the write buffer WB is prevented from being exhausted due to the erase operation to a superblock. Thus, reliable response performance to a write request can be achieved.

In addition, according to the embodiment, the memory controller 11 manages superblocks. Each of the superblocks is formed of the first number of blocks BLK selected one-by-one from the first number of memory chips CP. The superblocks are different in the first number of blocks BLK selected one-by-one from the first number of memory chips CP. The superblocks include at least a first superblock and a second superblock. The memory controller 11 causes each of the second number of memory chips CP included in the first group to perform the first erase operation to erase the data stored in the block BLK of each of the second number of the memory chips CP that is included in the first superblock, and causes the one or more memory chips CP included in the second group to perform the program operation or the sense operation to the blocks BLK of the one or more of the memory chips CP that are included in the second superblock, while the first erase operation is being performed in each of the second number of memory chips CP included in the first group.

Therefore, the available storage space in the write buffer WB is prevented from being exhausted due to the erase operation to a superblock. Thus, reliable response performance to a write request can be achieved.

### Modifications

In the above-described example, the dispersion interval and the divided erase parallel number are described as fixed values determined by the designer. The memory controller 11 may be configured to autonomously change the dispersion interval and/or the divided erase parallel number.

In a case where a plurality of input blocks is provided, when two or more input blocks transition to active blocks in a short period of time, a plurality of new input blocks may be required in a short period of time. In such a case, a plurality of erased blocks is required to be generated in a short period of time and thus the amount of time available for the erase operation to one superblock is limited. Thus, in a modification, provided that the write buffer WB has a sufficient available storage space, the memory controller 11 changes the dispersion interval or the divided erase parallel number to reduce the time required for the erase operation as much as possible.

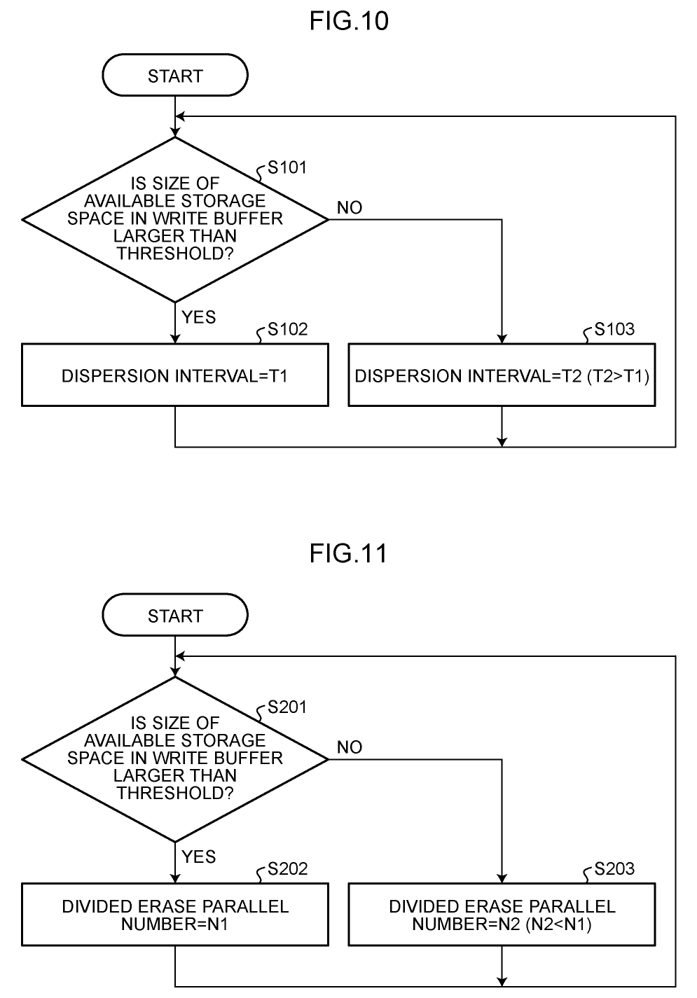

FIG. 10 is a flowchart illustrating an exemplary operation of changing a parameter value according to the modification.

The memory controller 11 acquires the size of the available storage space in the write buffer WB and determines whether or not the size of the available storage space is larger than a predetermined threshold (S101). In a case where the size of the available storage space is larger than the threshold (S101: Yes), the memory controller 11 sets the dispersion interval to a certain value T1 (S102). In a case where the size of the available storage space is not larger than the threshold (S101: No), the memory controller 11 sets the dispersion interval to a value T2 larger than the value T1 (S103). After Step S102 or Step S103, the control transitions to Step S101.

As described above, in a case where the size of the available storage space in the write buffer WB is larger than the threshold, the memory controller 11 shortens the dispersion interval for priority to the erase operation. In a case where the size of the available storage space in the write buffer WB is smaller than the threshold, the memory controller 11 lengthens the dispersion interval in order to prevent the available storage space from being exhausted.

Note that, in the example illustrated in FIG. 10, in a case where the size of the available storage space in the write buffer WB is equal to the threshold, the control transitions to Step S103, but in such a case, the control may transition to Step S102.

In addition, in the example illustrated in FIG. 10, the dispersion interval is changed in a two-phase manner in accordance with the size of the available storage space in the write buffer WB. The dispersion interval may be changed in a three-or-more-phase manner or linearly. At least in a case where the size of the available storage space of the write buffer WB is a first value, the memory controller 11 sets a third value as the dispersion interval. In a case where the size of the available storage space of the write buffer WB is a second value smaller than the first value, the memory controller 11 sets a fourth value larger than the third value as the dispersion interval.

FIG. 11 is a flowchart illustrating another exemplary operation of changing a parameter value according to the modification.

The memory controller 11 acquires the size of the available storage space in the write buffer WB and determines whether or not the size of the available storage space is larger than a predetermined threshold (S201). In a case where the size of the available storage space is larger than the threshold (S201: Yes), the memory controller 11 sets the divided erase parallel number to N1 (S202). In a case where the size of the available storage space is not larger than the threshold (S201: No), the memory controller 11 sets the divided erase parallel number to N2 smaller than N1 (S203). After Step S202 or Step S203, the control transitions to Step S201.

As above, when the size of the available storage space in the write buffer WB is larger than the threshold, the memory controller 11 increases the divided erase parallel number for priority to the erase operation. When the size of the available storage space in the write buffer WB is smaller than the threshold, the memory controller 11 decreases the divided erase parallel number in order to prevent the available storage space from being exhausted.

Note that, in the example illustrated in FIG. 11, in a case where the size of the available storage space in the write buffer WB is equal to the threshold, the control transitions to Step S203, but in such a case, the control may transition to Step S202.

In addition, in the example illustrated in FIG. 11, the divided erase parallel number is changed in a two-phase manner in accordance with the size of the available storage space in the write buffer WB. The divided erase parallel number may be changed in a three-or-more-phase manner. At least in a case where the size of the available storage space of the write buffer WB is a first value, the memory controller 11 sets a fifth value as the divided erase parallel number. In a case where the size of the available storage space of the write buffer WB is a second value smaller than the first value, the memory controller 11 sets a sixth value smaller than the fifth value as the divided parallel number.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a first number of first memories operable in parallel, the first number being an integer of 2 or larger; and
a memory controller configured to:
manage a plurality of groups each including a second number of the first memories, the second number being an integer not smaller than 1 and smaller than the first number, the plurality of groups including at least a first group and a second group;
cause each of the first number of the first memories to perform a first erase operation such that the second number of the first memories included in each of the plurality of groups are caused to perform the first erase operation at timing different among the plurality of groups; and
cause one or more of the first memories included in the second group to perform a program operation or a sense operation while the first erase operation is being performed in each of the second number of the first memories included in the first group.

2. The memory system according to claim 1, wherein
the plurality of groups further includes a third group, and
the memory controller is further configured to:
cause each of the second number of the first memories included in the first group to perform the first erase operation at a first timing;
cause each of the second number of the first memories included in the second group to perform the first erase operation at a second timing after the first timing, a time interval between the first timing and the second timing being a first set time; and
cause each of the second number of the first memories included in the third group to perform the first erase operation at a third timing after the second timing, a time interval between the second timing and the third timing being the first set time.

3. The memory system according to claim 2, wherein
the first number of the first memories each include a plurality of first storage areas each corresponding to a unit of an erase operation, and
the memory controller is further configured to:
manage a plurality of second storage areas each including the first number of the first storage areas selected one-by-one from the first number of the first memories, the first number of the first storage areas selected one-by-one from the first number of the first memories being different among the plurality of second storage areas, the plurality of second storage areas including at least a third storage area and a fourth storage area;
cause each of the second number of the first memories included in the first group to perform the first erase operation to erase data stored in the first storage area of each of the second number of the first memories that is included in the third storage area; and
cause the one or more of the first memories included in the second group to perform the program operation or the sense operation on the first storage areas of the one or more of the first memories that are included in the fourth storage area, while the first erase operation is being performed in each of the second number of the first memories included in the first group.

4. The memory system according to claim 1, wherein
the first number of the first memories each include a storage area,
the first number of the first memories are each configured to erase data stored in the storage area by R number of erase operations including at least the first erase operation, R being an integer of 2 or larger, and
the memory controller is further configured to:
cause each of the second number of the first memories included in the first group to perform an M-th erase operation of the R number of erase operations at a first timing, M being an integer not smaller than 1 and not larger than (R - 1);
cause each of the second number of the first memories included in the second group to perform the M-th erase operation of the R number of erase operations at a second timing after the first timing;
cause each of the second number of the first memories included in the first group to perform an (M + 1)-th erase operation of the R number of erase operations at a third timing after the second timing; and
cause the one or more of the first memories included in the second group to perform the program operation or the sense operation in a period of time from the first timing to the second timing.

5. The memory system according to claim 4, wherein
the memory controller is further configured to cause each of the second number of the first memories included in the second group to perform the (M + 1)-th erase operation of the R-number of erase operations at a fourth timing after the third timing,
a time interval between the first timing and the third timing is a second set time, and
a time interval between the second timing and the fourth timing is the second set time.

6. The memory system according to claim 5, wherein
the first number of the first memories each include a plurality of first storage areas each corresponding to a unit of an erase operation, and
the memory controller is further configured to:
manage a plurality of second storage areas each including the first number of the first storage areas selected one-by-one from the first number of the first memories, the first number of the first storage areas selected one-by-one from the first number of the first memories being different among the plurality of second storage areas, the plurality of second storage areas including at least a third storage area and a fourth storage area;
cause each of the second number of the first memories included in the first group to perform the first erase operation to erase data stored in the first storage area of each of the second number of the first memories that is included in the third storage area; and
cause the one or more of the first memories included in the second group to perform the program operation or the sense operation on the first storage areas of the one or more of the first memories that are included in the fourth storage area, while the first erase operation is being performed in each of the second number of the first memories included in the first group.

7. The memory system according to claim 4, wherein
the first number of the first memories each include a plurality of first storage areas each corresponding to a unit of an erase operation, and
the memory controller is further configured to:
manage a plurality of second storage areas each including the first number of the first storage areas selected one-by-one from the first number of the first memories, the first number of the first storage areas selected one-by-one from the first number of the first memories being different among the plurality of second storage areas, the plurality of second storage areas including at least a third storage area and a fourth storage area;
cause each of the second number of the first memories included in the first group to perform the first erase operation to erase data stored in the first storage areas of each of the second number of the first memories that is included in the third storage area; and
cause the one or more of the first memories included in the second group to perform the program operation or the sense operation on the first storage areas of the one or more of the first memories that are included in the fourth storage area, while the first erase operation is being performed in each of the second number of the first memories included in the first group.

8. The memory system according to claim 1, further comprising:
a second memory including a write buffer, wherein
the memory controller is further configured to:
receive first data that is required to be written by a write request from a host;
store the first data into the write buffer of the second memory;
cause the one or more of the first memories included in the second group to perform the program operation; and
in causing the one or more of the first memories included in the second group to perform the program operation, write the first data stored in the write buffer into any of the one or more of the first memories included in the second group through the program operation.

9. The memory system according to claim 1, wherein
the first number of the first memories each include a plurality of first storage areas each corresponding to a unit of an erase operation, and
the memory controller is further configured to:
manage a plurality of second storage areas each including the first number of the first storage areas selected one-by-one from the first number of the first memories, the first number of the first storage areas selected one-by-one from the first number of the first memories being different among the plurality of second storage areas, the plurality of second storage areas including at least a third storage area and a fourth storage area;
cause each of the second number of the first memories included in the first group to perform the first erase operation to erase data stored in the first storage area of each of the second number of the first memories that is included in the third storage area; and
cause the one or more of the first memories included in the second group to perform the program operation or the sense operation on the first storage areas of the one or more of the first memories that are included in the fourth storage area, while the first erase operation is being performed in each of the second number of the first memories included in the first group.

10. The memory system according to claim 1, further comprising:
a second memory including a write buffer, wherein
the memory controller is further configured to:
receive first data that is required to be written by a write request from a host;
store the first data into the write buffer of the second memory;
cause the one or more of the first memories included in the second group to perform the program operation;
in causing the one or more of the first memories included in the second group to perform the program operation, write the first data stored in the write buffer into any of the one or more of the first memories included in the second group through the program operation;
cause each of the second number of the first memories included in the first group to perform the first erase operation at a first timing;
cause each of the second number of the first memories included in the second group to perform the first erase operation at a second timing after the first timing;
set a time interval between the first timing and the second timing to a third value in a case where a size of an available storage space in the write buffer is a first value; and
set the time interval between the first timing and the second timing to a fourth value larger than the third value in a case where the size of the available storage space in the write buffer is a second value smaller than the first value.

11. The memory system according to claim 1, further comprising:
a second memory including a write buffer, wherein
the memory controller is further configured to:
receive first data that is required to be written by a write request from a host;
store the first data into the write buffer of the second memory;
cause the one or more of the first memories included in the second group to perform the program operation;
in causing the one or more of the first memories included in the second group to perform the program operation, write the first data stored in the write buffer into any of the one or more of the first memories included in the second group through the program operation;
set the second number to a third value in a case where a size of an available storage space in the write buffer is a first value; and
set the second number to a fourth value smaller than the third value in a case where the size of the available storage space in the write buffer is a second value smaller than the first value.

12. A method of controlling a first number of first memories operable in parallel, the first number being an integer of 2 or larger, the method comprising:
managing a plurality of groups each including a second number of the first memories, the second number being an integer not smaller than 1 and smaller than the first number, the plurality of groups including at least a first group and a second group;
causing each of the first number of the first memories to perform a first erase operation such that the second number of the first memories included in each of the plurality of groups are caused to perform the first erase operation at timing different among the plurality of groups; and
causing one or more of the first memories included in the second group to perform a program operation or a sense operation while the first erase operation is being performed in each of the second number of the first memories included in the first group.

13. The method according to claim 12, wherein
the plurality of groups further includes a third group, and
the method further comprises:
causing each of the second number of the first memories included in the first group to perform the first erase operation at a first timing;
causing each of the second number of the first memories included in the second group to perform the first erase operation at a second timing after the first timing, a time interval between the first timing and the second timing being a first set time; and
causing each of the second number of the first memories included in the third group to perform the first erase operation at a third timing after the second timing, a time interval between the second timing and the third timing being the first set time.

14. The method according to claim 13, wherein
the first number of the first memories each include a plurality of first storage areas each corresponding to a unit of an erase operation, and
the method further comprises:
managing a plurality of second storage areas each including the first number of the first storage areas selected one-by-one from the first number of the first memories, the first number of the first storage areas selected one-by-one from the first number of the first memories being different among the plurality of second storage areas, the plurality of second storage areas including at least a third storage area and a fourth storage area;
causing each of the second number of the first memories included in the first group to perform the first erase operation to erase data stored in the first storage area of each of the second number of the first memories that is included in the third storage area; and
causing the one or more of the first memories included in the second group to perform the program operation or the sense operation on the first storage areas of the one or more of the first memories that are included in the fourth storage area, while the first erase operation is being performed in each of the second number of the first memories included in the first group.

15. The method according to claim 12, wherein
the first number of the first memories each include a storage area,
the first number of the first memories are each configured to erase data stored in the storage area by R number of erase operations including at least the first erase operation, R being an integer of 2 or larger, and
the method further comprises:
causing each of the second number of the first memories included in the first group to perform an M-th erase operation of the R number of erase operations at a first timing, M being an integer not smaller than 1 and not larger than (R - 1);
causing each of the second number of the first memories included in the second group to perform the M-th erase operation of the R number of erase operations at a second timing after the first timing;
causing each of the second number of the first memories included in the first group to perform an (M + 1)-th erase operation of the R number of erase operations at a third timing after the second timing; and
causing the one or more of the first memories included in the second group to perform the program operation or the sense operation in a period of time from the first timing to the second timing.

16. The method according to claim 15, further comprising:
causing each of the second number of the first memories included in the second group to perform the (M + 1)-th erase operation of the R-number of erase operations at a fourth timing after the third timing, wherein
a time interval between the first timing and the third timing is a second set time, and
a time interval between the second timing and the fourth timing is the second set time.

17. The method according to claim 12, further comprising:
receiving first data that is required to be written by a write request from a host;
storing the first data into a write buffer of a second memory;
causing the one or more of the first memories included in the second group to perform the program operation; and
in causing the one or more of the first memories included in the second group to perform the program operation, writing the first data stored in the write buffer into any of the one or more of the first memories included in the second group through the program operation.

18. The method according to claim 12, wherein
the first number of the first memories each include a plurality of first storage areas each corresponding to a unit of an erase operation, and
the method further comprises:
managing a plurality of second storage areas each including the first number of the first storage areas selected one-by-one from the first number of the first memories, the first number of the first storage areas selected one-by-one from the first number of the first memories being different among the plurality of second storage areas, the plurality of second storage areas including at least a third storage area and a fourth storage area;
causing each of the second number of the first memories included in the first group to perform the first erase operation to erase data stored in the first storage areas of each of the second number of the first memories that is included in the third storage area; and
causing the one or more of the first memories included in the second group to perform the program operation or the sense operation on the first storage areas of the one or more of the first memories that are included in the fourth storage area, while the first erase operation is being performed in each of the second number of the first memories included in the first group.

19. The method according to claim 12, further comprising:
receiving first data that is required to be written by a write request from a host;
storing the first data into a write buffer of a second memory;
causing the one or more of the first memories included in the second group to perform the program operation;
in causing the one or more of the first memories included in the second group to perform the program operation, writing the first data stored in the write buffer into any of the one or more of the first memories included in the second group through the program operation;
causing each of the second number of the first memories included in the first group to perform the first erase operation at a first timing;
causing each of the second number of the first memories included in the second group to perform the first erase operation at a second timing after the first timing; and
setting different values for a time interval between the first timing and the second timing in accordance with a size of an available storage space in the write buffer.

20. The method according to claim 12, further comprising:
receiving first data that is required to be written by a write request from a host;
storing the first data into a write buffer of a second memory;
causing the one or more of the first memories included in the second group to perform the program operation;
in causing the one or more of the first memories included in the second group to perform the program operation, writing the first data stored in the write buffer into any of the one or more of the first memories included in the second group through the program operation; and
setting different values for the second number in accordance with a size of an available storage space in the write buffer is a first value.
